(19) United States
(12) Patent Application Publication
(10) Pub. No.: US 2026/0313748 A1
(43) Pub. Date: Oct. 8, 2026

(54) CORE NETWORK DEVICES ASSOCIATED WITH PDU SESSION RELEASE OR RE-ESTABLISHMENT

(71) Applicant: InterDigital Patent Holdings, Inc., Wilmington, DE (US)

(72) Inventors: Magurawalage Chathura Madhusanka Sarathchandra, London (GB); Michael Starsinic, Newtown, PA (US); Rocco Di Girolamo, Laval (CA); Achref Methenni, Laval (CA); Xavier De Foy, Kirkland (CA)

(73) Assignee: InterDigital Patent Holdings, Inc., Wilmington, DE (US)

(21) Appl. No.: 19/483,467

(22) PCT Filed: May 8, 2024
(86) PCT No.: PCT/US2024/028319

§ 371 Date: Nov. 11, 2025

Related U.S. Application Data
(60) Provisional application No. 63/465,659, filed on May 11, 2023.

(51) Int. Cl. H04W 76/30; H04W 24/08; H04W 48/18

(52) U.S. Cl. CPC H04W 76/30; H04W 24/08; H04W 48/18

(57) ABSTRACT

Disclosed herein are systems, methods, and instrumentalities associated with protocol data unit (PDU) session release and/or re-establishment. A first message may be received from a device. The device may be a network node and/or a WTRU. The first message may UPF SMF indicate that the network node is to monitor for an event associated with releasing a protocol data unit (PDU) session. It may be determined that the event has occurred when a criterion is satisfied. A second message may be sent to the device. The second message may indicate a notification that the event has occurred. A third message may be received in response to sending the notification. The second message may indicate that a release of the PDU session is to be triggered.

### CROSS-REFERENCE TO RELATED APPLICATIONS

This application claims the benefit of Provisional U.S. Patent Application No. 63/465,659, filed May 11, 2023, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Disclosed herein are systems, methods, and instrumentalities associated with protocol data unit (PDU) session release and/or re-establishment. According to embodiments of the disclosure, a network device (e.g., a session management function or SMF) may include a processor configured to determine that a protocol data unit (PDU) session release or re-establishment may be performed, and send a first message to another network device (a user plane function or UPF), wherein the first message may indicate that the other network device may determine and report a suitable time for performing the PDU session release or re-establishment. The processor of the core network device may be further configured to receive a notification from the other core network device indicating the suitable time for performing the PDU session release or re-establishment and transmit a second message to trigger the PDU session release or re-establishment. In examples, the first message may further indicate one or more criteria for determining the suitable time for performing the PDU session release or re-establishment. For instance, the one or more criteria may include the detection of an end of a burst, the detection of a traffic pattern, or the detection of no traffic. In examples, the notification received from the other core network device may further indicate the criteria used by the other core network device to determine the suitable time for performing the PDU session release or re-establishment.

Disclosed herein are systems, methods, and instrumentalities associated with protocol data unit (PDU) session release and/or re-establishment. According to embodiments of the disclosure, a wireless transmit/receive unit (WTRU) may include a processor configured to receive a first message from a network device, wherein the first message may indicate that the WTRU may determine and report a suitable time for performing a protocol data unit (PDU) session release or re-establishment. The processor may be further configured to determine, based at least on the first message, the suitable time for performing the PDU session release or re-establishment, and transmit a second message to the network device, wherein the second message may indicate the suitable time for performing the PDU session release or re-establishment.

Disclosed herein are systems, methods, and instrumentalities associated with protocol data unit (PDU) session release and/or re-establishment. According to embodiments of the disclosure, a base station may include a processor configured to receive a first message from a network device (e.g., a network node), wherein the first message may include a protocol data unit (PDU) session release or re-establishment command and an indication that delivery of the PDU session release or re-establishment command to a wireless transmit/receive unit (WTRU) may be delayed until a condition is met. The processor may be further configured to determine whether the condition is met and, in response to determining that the condition is met, transmit the PDU session release or re-establishment command to the WTRU.

Disclosed herein are systems, methods, and instrumentalities associated with protocol data unit (PDU) session release and/or re-establishment. According to embodiments of the disclosure, a core network device may include a processor configured to determine that a PDU session release or re-establishment is to be performed, and transmit a first message to a base station, wherein the first message may indicate that the base station may determine and report a suitable time for performing the PDU session release or re-establishment. The processor may be further configured to receive a notification from the base station, wherein the notification may indicate the suitable time determined by the base station for performing the PDU session release or re-establishment. In response to receiving the notification, the processor may be further configured to transmit a second message to the base station, wherein the second message may indicate that the PDU session release or re-establishment is to be performed (e.g., at the suitable time determined by the base station).

A network node and/or a method performed by a network node may be provided. The network node may comprise a processor, which may be configured to perform a number of actions. A first message may be received from a device. The device may be a network node and/or a WTRU. The first message may indicate that the network node is to monitor for an event associated with releasing a protocol data unit (PDU) session. It may be determined that the event has occurred when a criterion is satisfied. A second message may be sent to the device. The second message may indicate a notification that the event has occurred. A third message may be received in response to sending the notification. The second message may indicate that a release of the PDU session is to be triggered.

A network node and/or a method performed by a network node may be provided. The network node may comprise a processor, which may be configured to perform a number of actions. A first message may be received from a device. The device may be a network node and/or a WTRU. The first message may indicate that the network node is to monitor for an event associated with releasing a protocol data unit (PDU) session. It may be determined that the event has occurred when a criterion is satisfied. A second message may be sent to the device. The second message may indicate a notification that the event has occurred. A third message may be received in response to sending the notification. The second message may indicate that a release of the PDU session is to be triggered.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of changing a PDU session anchor (PSA) for a PDU session.

FIG. 3 is a diagram illustrating an example of changing a PSA associated with multiple PDU sessions.

FIG. 4 is a diagram illustrating an example of a multi-homed PDU session in a service continuity use case.

FIG. 5 is a diagram illustrating an example of detecting a suitable time for PDU session release or re-reestablishment, and initiating the PDU session release or re-reestablishment.

FIG. 6 is a diagram illustrating another example of detecting a suitable time for PDU session release or re-reestablishment, and initiating the PDU session release or re-reestablishment.

FIG. 7 is a diagram illustrating an example of delaying a PDU session release or re-reestablishment.

FIG. 8 is a diagram illustrating yet another example of detecting a suitable time for PDU session release or re-reestablishment, and initiating the PDU session release or re-reestablishment.

### DETAILED DESCRIPTION

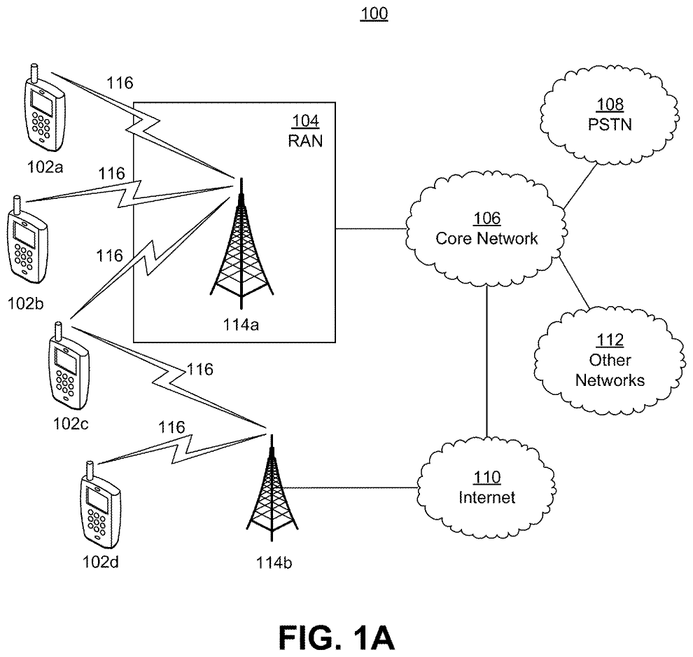

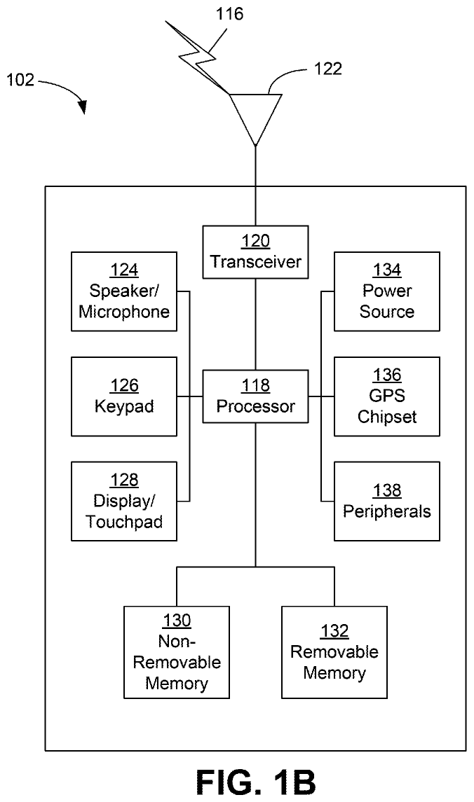

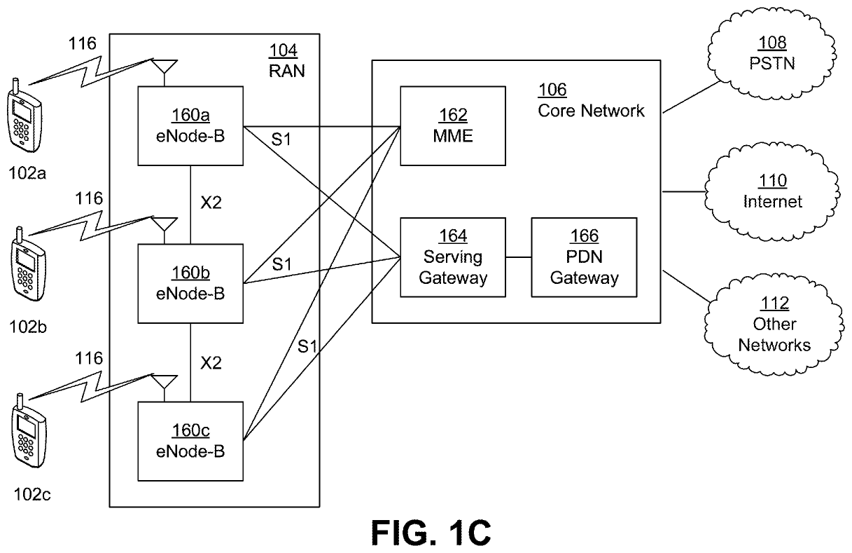

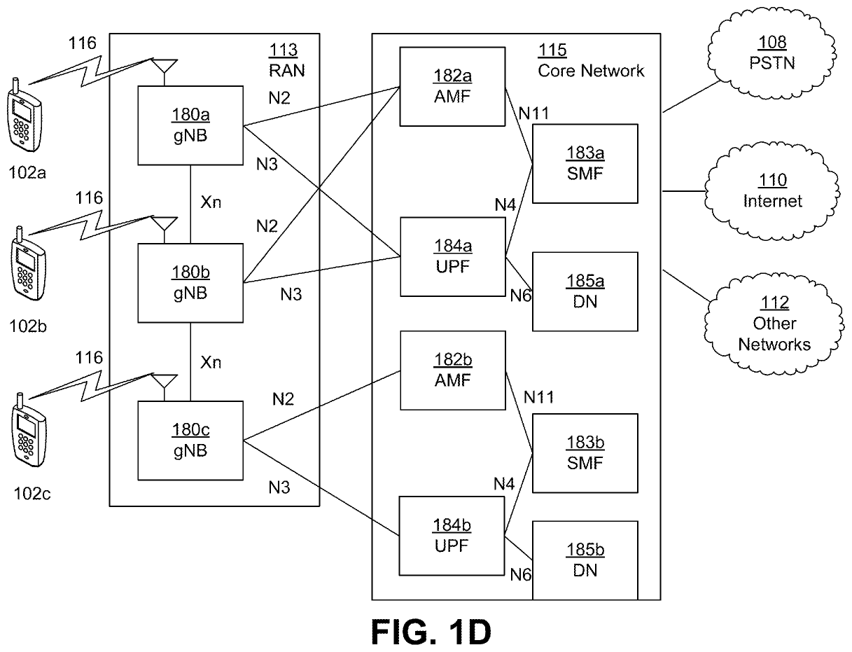

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (base station), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QOS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

Disclosed herein are systems, methods, and instrumentalities associated with protocol data unit (PDU) session release and/or re-establishment. According to embodiments of the disclosure, a core network device (e.g., a session management function or SMF) may include a processor configured to determine that a protocol data unit (PDU) session release or re-establishment may be performed, and transmit a first message to another core network device (a user plane function or UPF), wherein the first message may indicate that the other core network device may determine and report a suitable time for performing the PDU session release or re-establishment. The processor of the core network device may be further configured to receive a notification from the other core network device indicating the suitable time for performing the PDU session release or re-establishment, and transmit a second message to trigger the PDU session release or re-establishment. In examples, the first message may further indicate one or more criteria for determining the suitable time for performing the PDU session release or re-establishment. For instance, the one or more criteria may include detection of an end of a burst, detection of a traffic pattern, or detection of no traffic. In examples, the notification received from the other core network device may further indicate the criteria used by the other core network device to determine the suitable time for performing the PDU session release or re-establishment.

Disclosed herein are systems, methods, and instrumentalities associated with protocol data unit (PDU) session release and/or re-establishment. According to embodiments of the disclosure, a wireless transmit/receive unit (WTRU) may include a processor configured to receive a first message from a network device, wherein the first message may indicate that the WTRU may determine and report a suitable time for performing a protocol data unit (PDU) session release or re-establishment. The processor may be further configured to determine, based at least on the first message, the suitable time for performing the PDU session release or re-establishment, and transmit a second message to the network device, wherein the second message may indicate the suitable time for performing the PDU session release or re-establishment.

In some examples, the processor of the WTRU may be further configured to initiate the PDU session release or re-establishment at the suitable time, while in other examples the processor may be configured to receive a third message from the network device indicating that the PDU session release or re-establishment is to be initiated at the suitable time, and perform the PDU session release or re-establishment based on the third message and the suitable time.

In examples, the first message received from the network device may include a reference number associated with a data network access identifier. In examples, the first message may further indicate one or more criteria for determining the suitable time for performing the PDU session release or re-establishment. The one or more criteria may include detection of an end of a burst, detection of a traffic pattern, or detection of no traffic.

In examples, the processor of the WTRU may be further configured to transmit a third message to the network device, wherein the third message may include a PDU session establishment request.

Disclosed herein are systems, methods, and instrumentalities associated with protocol data unit (PDU) session release and/or re-establishment. According to embodiments of the disclosure, a base station may include a processor configured to receive a first message from a core network device, wherein the first message may include a protocol data unit (PDU) session release or re-establishment command and an indication that delivery of the PDU session release or re-establishment command to a wireless transmit/receive unit (WTRU) may be delayed until a condition is met. The processor may be further configured to determine whether the condition is met and, in response to determining that the condition is met, transmit the PDU session release or re-establishment command to the WTRU.

In examples, in response to determining that the condition is not met within a time period, the processor of the base station may be further configured to transmit a second message to the core network device indicating that the PDU session release or re-establishment command is not transmitted to the WTRU. In examples, the first message received by the base station may further indicate the condition, which may be associated with an end of a burst or expiration of a time period.

In examples, the delayed PDU session release or re-establishment command may be transmitted to the WTRU in a radio resource control (RRC) message, wherein the RRC message may further indicate that the PDU session release or re-establishment command is a delayed command from the core network device.

Disclosed herein are systems, methods, and instrumentalities associated with protocol data unit (PDU) session release and/or re-establishment. According to embodiments of the disclosure, a core network device may include a processor configured to determine that a PDU session release or re-establishment is to be performed, and transmit a first message to a base station, wherein the first message may indicate that the base station may determine and report a suitable time for performing the PDU session release or re-establishment. The processor may be further configured to receive a notification from the base station, wherein the notification may indicate the suitable time determined by the base station for performing the PDU session release or re-establishment. In response to receiving the notification, the processor may be further configured to transmit a second message to the base station, wherein the second message may indicate that the PDU session release or re-establishment is to be performed (e.g., at the suitable time determined by the base station).

In examples, the processor of the core network device may be configured to determine that the PDU session release or re-establishment is to be performed based on a determination that traffic associated with a first PDU session may be better served by a second PDU session, wherein the first PDU session may be associated with a first PDU anchor and the second PDU session may be associated with a second PDU anchor. In examples, the first message described herein may further indicate one or more quality of service flows to be monitored by the base station for determining the suitable time for performing the PDU session release or re-establishment.

A network node and/or a method performed by a network node may be provided. The network node may comprise a processor, which may be configured to perform a number of actions. A first message may be sent to a device. The device may be a network node and/or a WTRU. The first message may indicate that the device is to monitor for an event associated with releasing a protocol data unit (PDU) session. A second message may be received from the device. The second message may indicate a notification that the event has occurred. A third message may be sent to the device in response to receiving the notification. The second message may indicate that a release of the PDU session is to be triggered.

In an example, configuration information associated with the PDU session may be determined. The configuration information may comprise at least one of a data network name (DNN) or a single slice selection assistance information (S-NSSAI). Based on the configuration information, it may be determined that device coordination is to be used for releasing the PDU session. The event may be detected and/or determined when it is determined that device coordination is to be used for releasing the PDU session.

In an example, the event may be associated with an end of burst.

In an example, the PDU session may be associated with a session and service continuity (SCC) mode 2.

In an example, sending the first message may comprise sending the first message to the device when it is determined that the PDU session is to be released.

In an example, the second message may further indicate at least one of a time to release the PDU session, a criterion for predicting the time to release the PDU session, or a rule for predicting the time to release the PDU session.

In an example, the second message may further indicate a confidence level, wherein the confidence level indicates a probability that the event occurred.

A network node and/or a method performed by a network node may be provided. The network node may comprise a processor, which may be configured to perform a number of actions. A first message may be received from a device. The device may be a network node and/or a WTRU. The first message may indicate that the network node is to monitor for an event associated with releasing a protocol data unit (PDU) session. It may be determined that the event has occurred when a criterion is satisfied. A second message may be sent to the device. The second message may indicate a notification that the event has occurred. A third message may be received in response to sending the notification. The second message may indicate that a release of the PDU session is to be triggered.

In an example, the event may be associated with an end of burst.

In an example, the PDU session may be associated with session and service continuity (SCC) mode 2.

In an example, one or more of the following may be determined: a time to release the PDU session, a criterion for predicting the time to release the PDU session, and a rule for predicting the time to release the PDU session.

In an example, the second message may further indicate at least one of a time to release the PDU session, a criterion for predicting the time to release the PDU session, or a rule for predicting the time to release the PDU session.

In an example, the criterion is at least one of an end of burst, a time to release the PDU session, a traffic threshold, a packet threshold, a duration of time that has expired, an arrival of data traffic, or an arrival of an amount of data during a duration of time.

The wireless communication system described herein may support one or more types of support session and service continuity (SSC) modes such as SSC mode 1, mode 2, and/or mode 3. For certain types of PDU sessions such as a PDU session associated with SSC mode 1, a network may preserve the connectivity service provided to a WTRU. For a PDU session using IPv4, IPv6, or IPv4v6, an IP address associated with the PDU session may be preserved. A network device or function such as a user plane function (UPF) may assume the role of a PDU session anchor, for example, at the establishment of the PDU session, and may maintain that role regardless of the access technology (e.g., access type and/or cells) that the WTRU may subsequently use to access the network. Additional PDU session anchors may be assigned (e.g., based on local policies) to a PDU session of SSC mode 1, for example, if IPv6 multihoming or an uplink (UL) classifier (CL) is applicable to the PDU session. These additional PDU session anchors may be released or allocated. The WTRU may not expect that an IPv6 prefix (e.g., an additional IPv6 prefix) may be maintained during the lifetime of the PDU session.

For certain types of PDU sessions such as a PDU session of SSC mode 2, a network device or function may release the connectivity service delivered to a WTRU and/or release the corresponding PDU session(s) associated with the connectivity service. The release of a PDU session may lead to the release of an IP address that may have been allocated to the WTRU (e.g., an IPv4, IPv6, and/or IPv4v6 IP address).

If a PDU session (e.g., of SSC mode 2) is associated with a (e.g., a single) PDU session anchor, the network may trigger the release of the PDU session and instruct a WTRU associated with the PDU session to establish a new PDU session (e.g., to the same data network). The trigger condition for the release may depend on operator policies (e.g., based on a request from an application function), on a load status, a combination thereof and/or the like. At the establishment of the new PDU Session, a UPF (e.g., a new UPF) may be selected to act as a PDU session anchor.

If a PDU session (e.g., of SSC mode 2) is associated with multiple PDU session anchors (e.g., in the case of a multi-homed PDU session or in the case that a UL CL may be applicable to the PDU session), one or more additional PDU session anchors may be released or allocated.

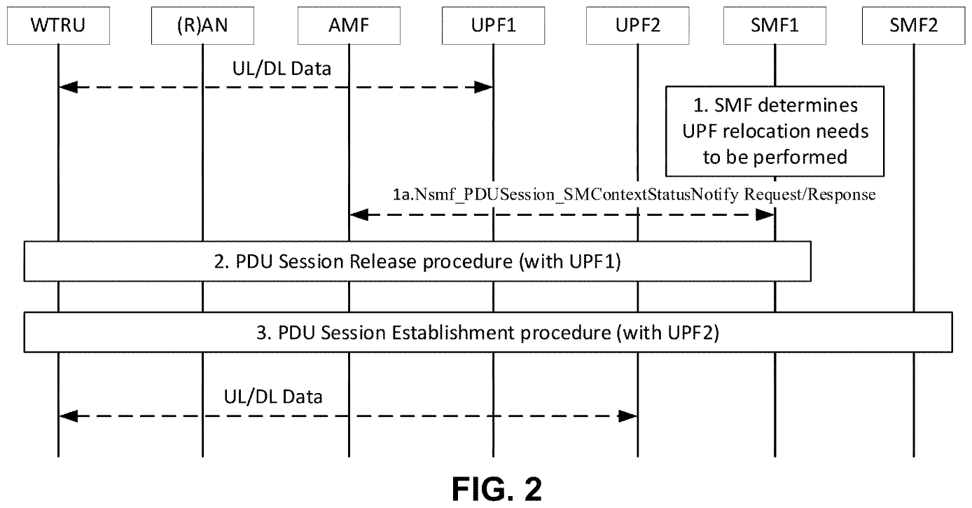

FIG. 2 illustrates an example of changing a PDU session anchor (PSA) for a PDU session in SSC mode 2 (e.g., in a break-before-make manner).

With one or more SSC modes such as SSC mode 3, changes to the user plane may be visible to a WTRU and the network may ensure that the WTRU suffers no loss of connectivity. A connection through a PDU session anchor point may be established before a previous connection is terminated, for example, to allow for better service continuity. An IP address (e.g., an IPv4, IPv6, or IPv4v6 IP address) may not be preserved in the SSC mode(s) (e.g., SSC mode 3) when the PDU session anchor changes.

The network may allow the establishment of WTRU connectivity via a PDU session anchor (e.g., a new PDU session anchor) to the same data network before connectivity between the WTRU and a previous PDU session anchor is released. When one or more triggering conditions are met, the network may decide whether to select a PDU session anchor (e.g., a UPF) suitable for the WTRU's current conditions (e.g., such as a point of attachment of the WTRU to the network).

If a PDU session (e.g., of SSC mode 3) has multiple PDU session anchors (e.g., in the case of a multi-homed PDU session or in the case that a UL CL may be applicable to the PDU session), one or more additional PDU session anchors may be released or allocated.

A PDU session anchor, such as a new PDU session anchor, may be associated with a PDU session, such as a new PDU session, or with the same PDU session (e.g., in the case of multi-homing).

In a network-requested PDU session modification procedure, if a selected SSC mode of the PDU session is SSC mode 3 and/or if the network (e.g., an SMF) requests the relocation of an SSC mode 3 PDU session anchor with multiple PDU sessions, the network (e.g., the SMF) may include a cause (e.g., such as “reactivation requested”) in a command message (e.g., such as a PDU_SESSION_MODIFICATION_COMMAND message) and may include a PDU session address lifetime in a PDU session address lifetime parameter in an information element (e.g., in the Extended_Protocol_Configuration_Options information element).

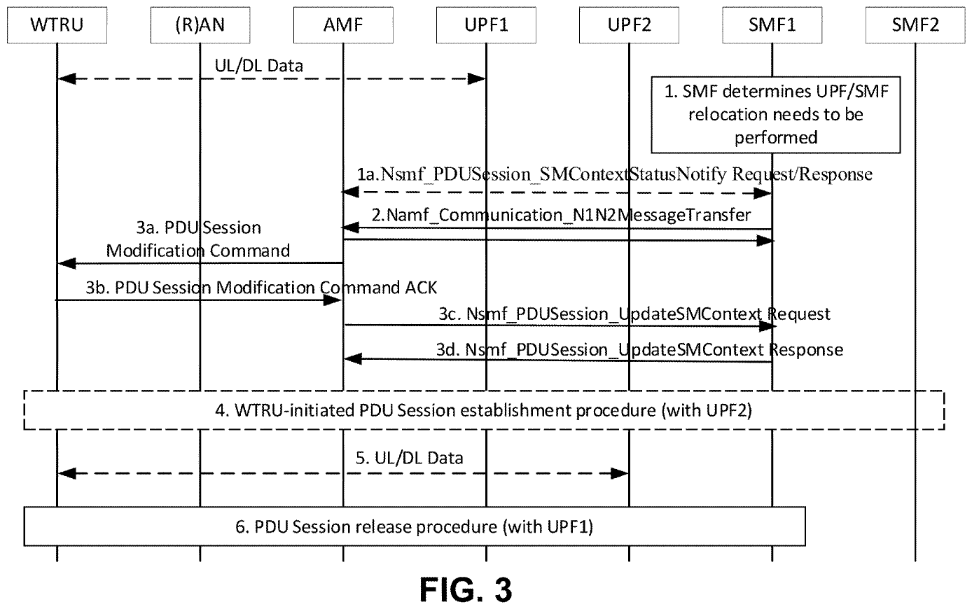

FIG. 3 illustrates an example of changing a PDU session anchor (PSA) for multiple PDU sessions in SSC mode 3 (e.g., in a make-before-break manner).

In SSC mode 1, such as described herein, a PDU session may be anchored at a network device or function such as a user plane function (UPF) in the core network. If a WTRU moves between different access networks (e.g., during a handover), a data path may be switched at the network device or function (e.g., at the UPF). The WTRU may maintain a PDU session (e.g., a single PDU session), and a data flow associated with the PDU session may be continuous during the handover. SSC mode 1 may provide seamless session and service continuity.

In SSC mode 2, such as described herein, a WTRU may establish separate PDU sessions for different access networks. If the WTRU moves between networks (e.g., during a handover), a data flow may be switched between the different PDU sessions at the WTRU. SSC mode 2 may not provide seamless session and service continuity (e.g., since the WTRU may establish a new PDU session when moving to a different network, which may cause temporary disruption in the data flow).

In SSC mode 3, such as described herein, as described herein may be a combination of SSC mode 1 and SSC mode 2. A WTRU may establish separate PDU sessions for different access networks (e.g., during a handover). A data flow may be switched at a network device or function such as the UPF, providing seamless session and service continuity.

SSC mode selection may be performed (e.g., by an SMF) based on allowed SSC modes (e.g., including a default SSC mode) in a user subscription, a PDU session type, an SSC mode requested by a WTRU, etc. An operator may provide an SSC mode selection policy (SSCMSP) to the WTRU, for example, as part of a UE Route selection policy (URSP) rule. If the WTRU is not provided with an SSCMSP, the WTRU may select an SSC mode based on the local configuration of the WTRU. If the WTRU cannot select an SSC mode, the WTRU may request a PDU session establishment without providing an SSC mode.

If the WTRU provides an SSC mode when requesting a PDU session establishment, the network (e.g., an SMF) may select an SSC mode by accepting the SSC mode provided by the WTRU, or by rejecting the PDU session establishment request from the WTRU (e.g., with a cause value) and indicating one or more allowable SSC modes to the WTRU (e.g., the allowable SSC modes may be determined based on the PDU session type, subscription and/or local configuration of the WTRU, etc.). Based on the cause value provided by the network and/or the allowable SSC mode(s) indicated by the network, the WTRU may re-attempt the PDU session establishment request with one of the allowable SSC modes or based on another URSP rule.

If the WTRU does not provide an SSC mode when requesting a PDU session establishment, the network (e.g., the SMF) may select a default SSC mode for a data network listed in the WTRU's subscription or select an SSC mode based on local configuration. The network (e.g., the SMF) may inform the WTRU of the selected SSC mode for a PDU session. The network may trigger a PDU session release (e.g., to enforce an SSC mode) with a cause code that may indicate a reason for reactivation (e.g., restoration or user plane path optimization).

The wireless communication network described herein may support local routing and/or traffic steering. The network may select the traffic to be routed to an application in a local part of a data network (DN). A (e.g., single) PDU session may be associated with multiple PDU session anchors (e.g., in the case of UL CL, IPv6 multi-homing, etc.). A PDU session may be associated with a distributed anchor point (e.g., in SSC mode 2 and/or mode 3).

The wireless communication network described herein may support selective traffic routing to a DN and/or SSC mode 3. The network (e.g., via an SMF) may control the data path of a PDU session so that the PDU session may (e.g., simultaneously) correspond to multiple N6 interfaces. A network function such as the UPF may terminate one or more (e.g., each) of these interfaces in support of PDU session anchor functionalities. A PDU session anchor associated with a PDU session may provide a different access to the same DN.

A PDU session anchor assigned at PDU session establishment may be associated with the SSC mode of the PDU session. For example, additional PDU session anchor(s) assigned within the same PDU session (e.g., for selective traffic routing to a DN) may be independent of the SSC mode of the PDU session. A network function such as the SMF may decide whether to apply traffic routing (e.g., using a UL classifier or IPv6 multi-homing) based on one or more data network access identifiers (DNAls) included in a policy and charging control (PCC) rule (e.g., comprising an AF influenced traffic steering enforcement control information), for example, if such a PCC rule is provided to the network function.

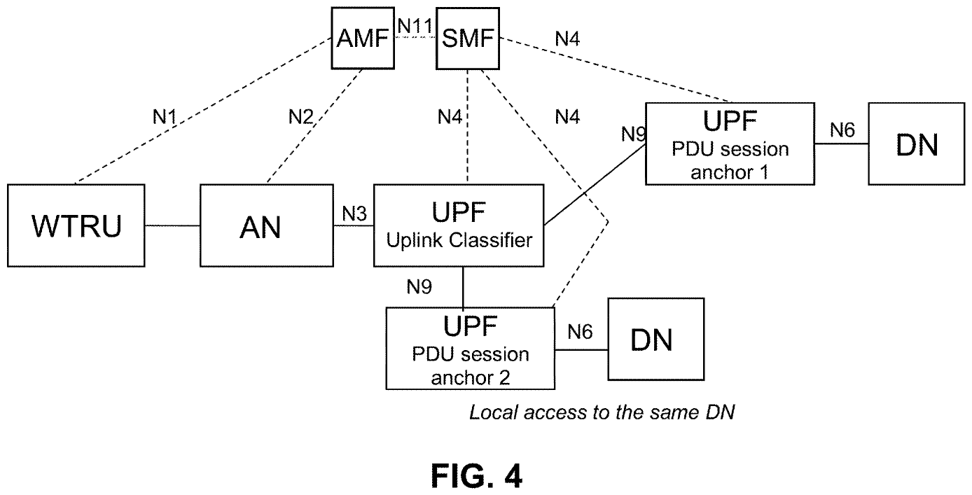

A multi-homed PDU session may be used to support make-before-break service continuity (e.g., in support of SSC mode 3), as illustrated in FIG. 4.

A data network access identifier (DNAI) may identify access to one or more data networks. As illustrated in FIG. 2, an existing PDU session associated with a first PDU session anchor (e.g., UPF1 in FIG. 2 and FIG. 3) may be released, and a new PDU session associated with a second PDU session anchor (e.g., UPF2 in FIG. 2 and FIG. 3) may be established to the same DN.

If a network function such as a UPF (e.g., serving as a PSA) cannot connect to a target DNAI or a common DNAI that the network function may receive from another network function (e.g., such as an SM-PCF), a network function such as an access and mobility management function (AMF) may be notified (e.g., by the SMF). The AMF may store the target DNAI information or the common DNAI received from the SMF. The target DNAI information received by AMF may be used for SMF selection, which may control how the UPF may connect to that DNAI towards the same DN and/or S-NSSAI. The SMF may select a new UPF (e.g., UPF2 in FIG. 2 and FIG. 3) for the re-established PDU session (e.g., of SSC mode 2). If an attribute (e.g., such as an indication of application relocation possibility attribute) in the PCC rule indicates that no DNAI change takes place, the SMF may determine that the SMF may not be changed.

A WTRU and an SMF may communicate via one or more NAS-SM messages. In the uplink, the WTRU may send a NAS-SM message to an AMF. The NAS-SM message may be sent to the AMF inside of a NAS-MM message. The AMF may forward the NAS-SM message to the SMF. When the AMF sends the NAS-SM message to the SMF, the message may be sent inside of an SMF service invocation message. When the AMF sends the NAS-SM message to the SMF, the AMF may send additional information to the SMF.

In the downlink, the SMF may send a NAS-SM message to the WTRU. The NAS-SM message may be sent to the AMF inside of an AMF service invocation message. The AMF may forward the NAS-SM message to the WTRU. When the AMF sends the NAS-SM message to the WTRU, the message may be sent inside of an NAS-MM message. When the AMF sends the NAS-SM message to the WTRU, the AMF may send additional information to the WTRU. The additional information may be sent inside the NAS-MM message.

PDU session establishment requests, PDU session modification requests, and PDU session release requests are examples of NAS-SM messages that the WTRU may send to the SMF. PDU session establishment accept messages, PDU session modification commands, and PDU session release commands are examples of NAS-SM messages that the SMF may send to the WTRU.

In examples, certain types of services may be handled by a specific SSC mode such as SSC mode 2 (e.g., such services may not be able to use other SSC modes such as SSC mode 1 or SSC mode 3). For example, some WTRUs and/or networks may not support SSC mode 3 functionalities. As another example, a quality of experience (QoE) criterion may be unacceptable for SSC mode 1, where a PDU session anchor may be maintained for a PDU session. The QoE criterion may not be acceptable for SSC mode 1 when transport delay increases in such a mode, if the WTRU transitions from one access node or network to another access node or network, or the WTRU moves away from a PSU session anchor (e.g., for these services, QoE may improve if the PDU session anchor may be changed, even if this may result in an interruption in service).

An anchor UPF may be associated with a PDU session. When SSC mode 2 is used, an SMF may determine that a second UPF different than the anchor UPF of the PDU session may be better suited to serve as the anchor for the PDU session. The SMF may make the determination based on detecting that the WTRU is geographically closer to the second UPF, based on an indication received from another network function or AF, or based on detecting that the second UPF may be geographically closer to a server that the WTRU may communicate with.

If the SMF determines that the second UPF may be better suited to serve as the anchor of the PDU session, the SMF may initiate a PDU session release procedure. In the PDU session release procedure, the SMF may indicate to the WTRU that the PDU session may be re-established after the release procedure is completed. The indication from the SMF may trigger the WTRU to establish a new PDU session and the second UPF may be selected to be the anchor of the new PDU session.

In an example, when SSC mode 2 is used, there may be a period of time between the release of a first PDU session and the establishment of a second PDU session. During this time, a WTRU may not be able to send or receive data associated with a service that may be using the first PDU session and may now use the second PDU session. The IP address of the WTRU may change, and a WTRU application may communicate the IP address (e.g., the new IP address) to a server that the WTRU may be in communication with. An SMF may initiate the release of a PDU session without regard to what type of traffic may be sent in the PDU session or what type of traffic may soon be sent in the PDU session. This may lead to releasing the PDU session at an inopportune time. Thus, enhancements may be implemented so that a PDU session release may be triggered in the WTRU at a time that may minimize service disruption and/or quality of experience degradation that may be perceived by the user.

A WTRU and/or a network device or function may be configured to detect a suitable time for releasing and re-establishing a PDU session that may be used by a service. This may enable the WTRU to use a specific SSC mode (e.g., SSC mode 2) and/or to minimize the amount of data that may be lost during the release or re-establishment of the PDU session.

The detection of the suitable time may be performed at a UPF, a base station (e.g., a RAN node), and/or a WTRU. The execution of a PDU session release procedure may be performed by an SMF or a WTRU. If a network function such as an SMF initiates a PDU session release, the network may configure any combination of the UPF, base station, and/or WTRU to detect when to release the PDU session. If a WTRU initiates a PDU session release, any combination of the UPF, WTRU, and/or base station may be configured to detect when to release the PDU session.

A condition associated with detecting a suitable release time may depend on the modalities that may be in use for monitored traffic. For example, for a video modality, one or more end-of-burst (EoB) criteria may be used for the suitable time detection. For a haptic modality, one or more priority-based criteria may be used for the suitable time detection.

A suitable time for releasing and re-establishing a PDU session may be detected using various methods. The suitable PDU release/reestablishment time (e.g., a suitable PDU release/switch condition) may include, but may one of the examples described herein.

For example, a suitable PDU release/reestablishment time may be after an EoB. A network node such as a network device or a WTRU may determine the end of a burst, for example, based on information included in the header of a PDU, or based on a known traffic periodicity. The network node may determine that a burst may have ended and that there may be a delay before the start of the next burst. This delay period may be a suitable time to perform a PDU session release and re-establishment.

For example, a suitable PDU release/reestablishment time may be before or after a specific time, such as, for example, when the next start of a burst is expected in X milliseconds (ms). For example, if a handover is expected to take X ms, this may ensure that a new PDU session may be available in time for the next burst.

For example, a suitable PDU release/reestablishment time may be when there is no traffic for a specific time period. A network node (e.g., a WTRU, a RAN node such as a base station, or a UPF) may determine that there may be a period of time with no traffic (referred to herein as a quiet time). Such a quiet time may be determined based on information included in the header of a PDU, or based on a known traffic periodicity. This quiet time may be a suitable time to perform a PDU session release and re-establishment.

For example, a suitable PDU release/reestablishment time may be when traffic that matches a certain service data flow (SDF) is detected (e.g., based on a traffic descriptor or application descriptor). For example, a node may determine that the traffic may be from a specific SDF (e.g., based on an SDF identifier carried in a PDU header) and the traffic may be of lower priority or lower importance. As another example, the network node may determine that the traffic from the SDF may be able to withstand a service interruption that may result from a change in a PSA (e.g., the traffic over this SDF may be loss insensitive). The time associated with such traffic may be a suitable time to perform a PDU session release (e.g., as the loss of traffic from this SDF may not impact the overall QoE).

For example, a suitable PDU release/reestablishment time may be determined based on a traffic modality (e.g., during transmission/reception of audio, video, or haptic data).

For example, a suitable PDU release/reestablishment time may be during, before, or after the transmission of a PDU set with certain characteristics. For example, a node may determine that the traffic from a PDU set may have PDU set integrated handling information (PSIHI) that may indicate that not all PDUs of the PDU set may be needed for the usage of the PDU set by an application layer on a receiver side. This may be a suitable time to perform a PDU session release (e.g., as the application layer may be able to manage one or more lost PDUs of the PDU set).

For example, a suitable PDU release/reestablishment time may be determined based on an application layer parameter, such as, for example, a codec used by the application.

For example, a suitable PDU release/reestablishment time may be during or in response to detecting an unused transmission occasion (e.g., in a RAN node or a WTRU).

For example, a suitable PDU release/reestablishment time may be during the transmission of low-priority data (e.g., low-priority flows, PDU sets, or PDUs) so as to avoid releasing or reestablishing a PDU session during high-priority data transmissions. For example, a PDU release or reestablishment may be performed after a high-importance PDU set has been received completely for a burst (e.g., when a base layer transmission may have been completely received). As another example, a node may determine that the traffic from a PDU set may have PSIHI, which may indicate that not all PDUs of the PDU set may be needed for the usage of the PDU set by an application layer on a receiver side. This may be a suitable time to perform a PDU session release (e.g., as the application layer may be able to manage one or more lost PDUs of the PDU set).

For example, a suitable PDU release/reestablishment time may be after the transmission of one or more (e.g., all) PDU sets with certain characteristics within a burst (e.g., one or more high-importance PDU sets within a burst).

For example, a suitable PDU release/reestablishment time may be after the start of a burst.

For example, a suitable PDU release/reestablishment time may be before the estimated time of the next burst.

For example, a suitable PDU release/reestablishment time may be when a WTRU is in a power saving state. A node may determine that the WTRU is in the power saving state based on known power savings patterns. For example, a RAN node may know when the WTRU may be in a connected node discontinuous reception (CDRX) mode, and that may be a suitable time to perform a PDU session release (e.g., as the service interruption may be timed to overlap with the CDRX period).

For example, a suitable PDU release/reestablishment time may be when the buffer status at a node (e.g., a RAN node such as a base station, a UPF, a WTRU, etc.) is below a threshold. In these situations, the node may buffer traffic before transmission. For example, a RAN node may buffer downlink traffic while waiting for the traffic to be scheduled by a base station. If the buffered traffic may be lost during a PDU session release, the node may perform the PDU session release when the buffer status is below a threshold (e.g., to minimize the number of lost PDUs). A suitable PDU release/reestablishment time may be when traffic matching a certain traffic pattern may be detected.

A network node (e.g., a WTRU, a UPF, or a RAN node such as a base station) configured to monitor a suitable PDU release/reestablishment time may pause (e.g., temporarily) the monitoring (e.g., for another opportunity or suitable time to release a PDU session) for a certain duration or time, for example, to give an SMF time to perform a PDU session release procedure and/or send a PDU session release command. This pause or waiting time period may be configured by the network. If the PDU release procedure is successful, the corresponding PDU session may be released and/or a UPF configuration associated with suitable PDU release/reestablishment time monitoring for the PDU session may be removed. If a WTRU is monitoring for corresponding traffic, it may stop sending suitable time notifications for a time period before continuing to send those notifications. The WTRU may determine when to stop the monitoring based on a received PDU session release command.

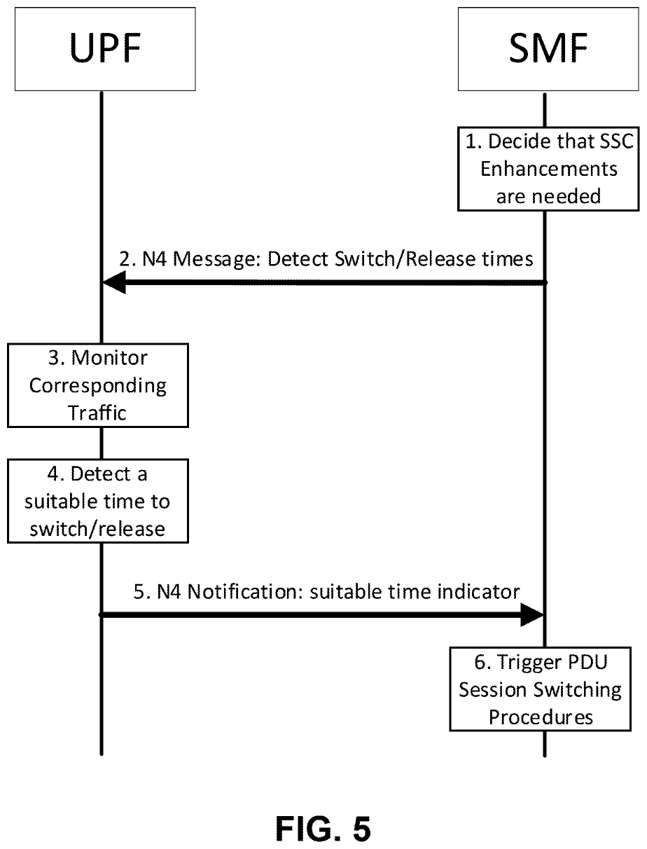

A UPF may be configured to detect a suitable time for releasing a PDU session, and an SMF may initiate a PDU session release based on detection information received from the UPF. FIG. 5 illustrates such an example. As shown in FIG. 5, the SMF may, at 1, determine that SSC mode 2 may be used for a PDU session, that there may be a UPF better suited to serve as an anchor of the PDU session, that the PDU session may be released so that a WTRU may establish a new PDU session, and/or that the timing of the release may be coordinated such that the release may occur at a suitable time. The SMF may determine that the timing of the release may be coordinated such that the release may occur at a suitable time based on PDU session configuration information. For example, the SMF may receive one or more service parameters associated with the PDU session from a unified data management (UDM) or a united data repository (UDR). The service parameters may indicate that the PDU session release may occur at a suitable time. The indication may be based on a combination of DNN and S-NSSAI of the PDU session. The indication may be included in a PDU session establishment request from the WTRU.

The SMF may determine that the release may be coordinated such that it may occur at a suitable time based on other information included in a PDU session establishment request. For example, an SSC mode may be created (e.g., SSC mode 4) in which a PDU session release may be attempted at a suitable time. The SMF may determine that the timing of the release may be coordinated based on conditions present in a PCC rule. For example, a PCC rule associated with a media flow may specify that, if SSC mode 2 is used, a list of conditions and associated parameters (e.g., as described herein) may be used to determine the timing for an SSC mode 2 handover. The SMF may be configured with a list of conditions and associated parameters for determining a timing of the SSC mode 2 handover (e.g., the conditions and/or parameters may be associated with a media transport protocol type or an application ID).

At 2 of FIG. 5, the SMF may, based on detecting that a release of the PDU session may be performed and/or determining that the release of the PDU session may occur at a suitable time, send a configuration message to the UPF, for example, over an N4 interface. The message may request the UPF to detect a suitable time to release the PDU session. The message may specify one or more applications, PDU sessions, or data flows that may be monitored for identifying the suitable time for releasing a PDU session. The message may instruct the UPF to monitor certain criteria or events to determine the right time (e.g., a duration of time) for the PDU session release. The message may specify which applications, PDU sessions, or data flows may be monitored. The message may indicate what constitutes a suitable time by including specific conditions and related parameters.

The SMF may specify (e.g., in the message) how the suitable time may be defined (e.g., by specifying one or more of the conditions described herein, along with related parameters). For example, the SMF may indicate a request (e.g., desire) to be notified when an event is detected, the event may be one or more of when an EoB is detected, when no traffic is detected in the PDU session for a period of time, or when a certain traffic pattern is detected.

At 3 of FIG. 5, the UPF may monitor traffic on one or more data flows associated with the specified PDU session. If the SMF has not specified how to detect the suitable time for releasing or reestablishing the PDU session, the UPF may use a default method for the detection.

At 4 of FIG. 5, the UPF may detect a condition or event that may match the criterion for a suitable time to release the PDU session, or the UPF may predict that the condition or event (e.g., arrival of certain type of traffic) may be met within a time period. The event may be one or more of when an EoB is detected, when no traffic is detected in the PDU session for a period of time, or when a certain traffic pattern is detected. The UPF may perform the prediction based on a preconfigured (e.g., by the SMF) traffic prediction model, with a certain level of probability (e.g., confidence).

At 5 of FIG. 5, the UPF may send a notification message to the SMF indicating that a suitable time to release the PDU session has occurred or may occur in a certain period of time. The message may indicate the criteria or rules used for the detection or prediction. The message may indicate if the UPF has detected a result or predicted the result. The UPF may send both detected and predicted results. The UPF may indicate a confidence level associated with a predicted result.

At 6 of FIG. 5, the SMF may determine that a PDU session release may be triggered, for example, based on information received from the UPF, and may trigger the PDU session release based on the determination. The SMF may consider predicted and/or detected results during the determination.

As illustrated by FIG. 5, an SMF may (e.g., at 2 shown in the figure) send a configuration message to an UPF over an N4 interface, requesting detection of a suitable time to release a PDU session. The suitable time may be defined as, for example, after an EoB, when there may be no traffic for a time period, or when traffic may match a certain service data flow. The SMF may (e.g., at 5 shown in FIG. 5) receive a notification message from the UPF indicating that a suitable time to release the PDU session has occurred or may occur soon. The notification message may indicate the criteria used by the UPF for the detection or prediction. The SMF may (e.g., at 6 shown in FIG. 5) send a PDU session release message, based on the notification message.

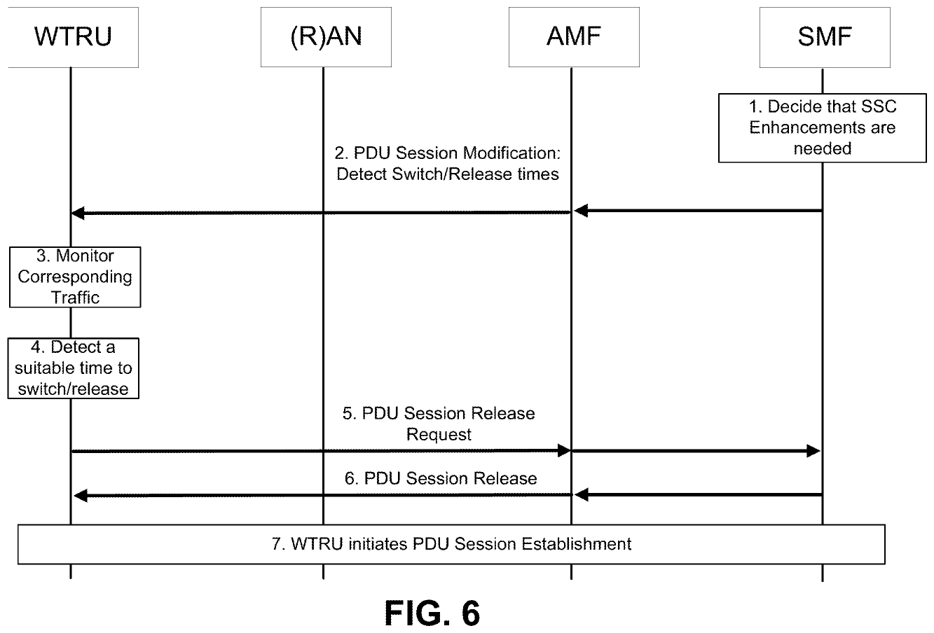

A WTRU may be configured to detect a suitable time for releasing a PDU session, and an SMF or the WTRU may initiate the release based on the detection. FIG. 6 shows such an example. At 1, an SMF may determine that a PDU session release may be performed. The determination may be made, for example, in similar manners as described at 1 of FIG. 5. The SMF may generate a reference number and send the reference number, a DNAI, a DNN, and/or an S-NSSAI to an AMF. The DNAI, DNN, and/or S-NSSAI may be stored by the AMF so that they may be used in a PDU session subsequently established by the WTRU, for example, with the same DNN/S-NSSAI combination. The reference number may be provided by the WTRU to the AMF, for example, as part of a PDU session establishment request. The reference number may be used by the AMF to determine the DNAI that may be associated with the PDU session (e.g., if the WTRU provides a different DNN/S-NSSAI combination during a PDU session establishment).

At 2 of FIG. 6, the SMF may send a PDU session modification command to the WTRU. The PDU session modification command may indicate a request for the WTRU to report when a suitable time to release a PDU session has been detected. The command may specify one or more applications or flows that may be monitored for identifying the suitable time for releasing the PDU session. The SMF may indicate how a suitable time may be defined. For example, the SMF may indicate that the WTRU may detect an EoB as the suitable time for releasing the PDU session, or when no traffic is sent or received in the PDU session for a time period, or when other SSC mode 2 handover conditions and associated parameters (e.g., as described herein) are met. If the SMF does not specify the detection method, the WTRU may use a default configuration to determine how to detect a suitable time for releasing the PDU session. The default configuration may indicate, for example, that a suitable time may be detected based on one or more of the parameters and methods described herein. The default configuration may be provided to the WTRU, for example, in a QoS rule-related information element. The WTRU may detect an EoB by inspecting uplink traffic, inspecting downlink traffic, or receiving an EoB indication from the base station in an RRC message. The PDU session modification command may include the reference number generated at 1.

At 3 of FIG. 6, the WTRU may monitor traffic on the specified PDU session and/or data flow in order to detect a suitable time to release the PDU session. If the SMF has not specified how to detect the suitable time for releasing the PDU session, the WTRU may use a default method.

At 4 of FIG. 6, the WTRU may detect traffic that may match the criteria for a suitable time to release the PDU session, or the WTRU may predict that such traffic may arrive within a time period (e.g., the prediction may be made with a certain level of probability or confidence).

At 5 of FIG. 6, the WTRU may send a PDU session release request message to the SMF indicating that a suitable time to release the PDU session has occurred or may occur within a time period. The message may indicate the criteria or rules used for the detection or prediction. The message may specify if the WTRU has detected the result or predicted the result. The message may include both detected and predicted results. The message may indicate that the release operation may be based on the PDU session modification command received at 2.

At 6 of FIG. 6, the SMF may proceed with a PDU session release procedure, for example, by sending a PDU session release command to the WTRU. The SMF may send the reference number generated at 1 to the WTRU at 6 (e.g., in the PDU session release command).

At 7 of FIG. 6, the WTRU may initiate the establishment of a new PDU session, for example, by sending a PDU session establishment request to the network. The PDU session establishment request and/or the reference number received at 2 may be included in a NAS-MM message to the AMF. The AMF may use the reference number in an SMF selection procedure and/or may determine a DNAI to provide to the SMF that the AMF may have selected to serve the PDU session. The WTRU may determine to include the reference number if (e.g., only if) the WTRU is using a DNN/S-NSSAI combination that may be different than the DNN/S-NSSAI combination associated with the PDU session released at 5.

At 5 of FIG. 6, the WTRU may a PDU session modification request (e.g., instead of a PDU session release request) to the SMF that may indicate that the detection of a suitable time to release the PDU session. The PDU session modification request may trigger the SMF to initiate a PDU session release procedure (e.g., at 6). The PDU session modification request may include the reference number provided at 2 so that the SMF may retrieve a previously determined DNAI. The PDU session modification request may include (e.g., instead of or in addition to the reference number) a PDU session ID of the PDU session associated with the PDU session modification command received at 2.

The SMF may (e.g., after sending the PDU session modification command at 3 and before the WTRU indicates that it has detected a suitable time to release the PDU session) determine that it may no longer wish to detect a suitable time to release the PDU session, and may send another PDU session modification command to the WTRU. The PDU session modification command may indicate that detection of a suitable time to release the PDU session may no longer be requested (e.g., desired).

At 2 and/or 5 of FIG. 6, an acknowledgment message to the PDU session modification command may be sent by the WTRU to confirm activation of the suitable time detection. After the SMF sends the PDU session modification command, the WTRU may indicate in the PDU session modification command acknowledgment message that the suitable time for release detection is activated. This way, the SMF may know that a release operation request from the WTRU for a specific PDU session may be related to the corresponding PDU session modification command (e.g., where the suitable time for release detection may be configured) and the indication at 5 may be skipped.

As illustrated in FIG. 6, an SMF may (at 2 of FIG. 6) send a PDU session modification command to a WTRU. The PDU session modification command may indicate a request for the WTRU to report when a suitable time to release the PDU session has been detected. The command may indicate what condition(s) may be detected by the WTRU to determine whether a suitable time to release the PDU session may have occurred. Examples of such conditions may include detection of an EoB in uplink traffic, detection of an EoB in downlink traffic, reception of an EoB indication from a base station in an RRC message, and/or detecting that a time period may have passed. The conditions may be indicated to the WTRU in one or more QoS rules. The PDU session modification command may include a reference number that may be associated with a DNAI. The SMF may (e.g., at 5 of FIG. 6) receive a NAS-SM message from the WTRU that may indicate to the SMF that the WTRU has detected a suitable time to release the PDU session. The NAS-SM message may be a PDU session release request message. The NAS-SM message may be a PDU session modification request message. The NAS-SM message may indicate the condition detected by the SMF that may indicate the suitable PDU release time (e.g., an EoB may be detected, or a timer may have expired). The SMF may (e.g., at 6 of FIG. 6) send a PDU session release command to the WTRU.

As illustrated by FIG. 6, a WTRU may (e.g., at 2 of FIG. 6) receive a PDU session modification command from an SMF. The PDU session modification command may indicate a request to report when a suitable time to release the PDU session has been detected. The request may indicate what condition(s) may be detected by the WTRU to determine the suitable time to release the PDU session. Examples of such conditions may include the detection of an EoB in uplink traffic, the detection of an EoB in downlink traffic, the reception of an EoB indication from a base station in an RRC message, and/or the detecting that a time period has passed. The conditions may be indicated to the WTRU in QoS rules. The request may include a reference number that may be associated with a DNAI. The WTRU may (e.g., at 3-4 of FIG. 6) detect a suitable time to release the PDU session and may send (e.g., at 5 of FIG. 6) a NAS-SM message to the SMF that may indicate to the SMF that the WTRU has detected a suitable time to release the PDU session. The NAS-SM message may be a PDU session release request message. The NAS-SM message may be a PDU session modification request message. The NAS-SM message may indicate the condition(s) detected by the WTRU (e.g., an EoB may be detected, or a timer may have expired) that may indicate the suitable PDU release time. The WTRU may (e.g., at 6 of FIG. 6) receive a PDU session release command from the SMF. The command may include a reference number that may be associated with a DNAI. The WTRU may (e.g., at 7 of FIG. 6) send a PDU session establishment request that may include the reference number associated with the DNAI.

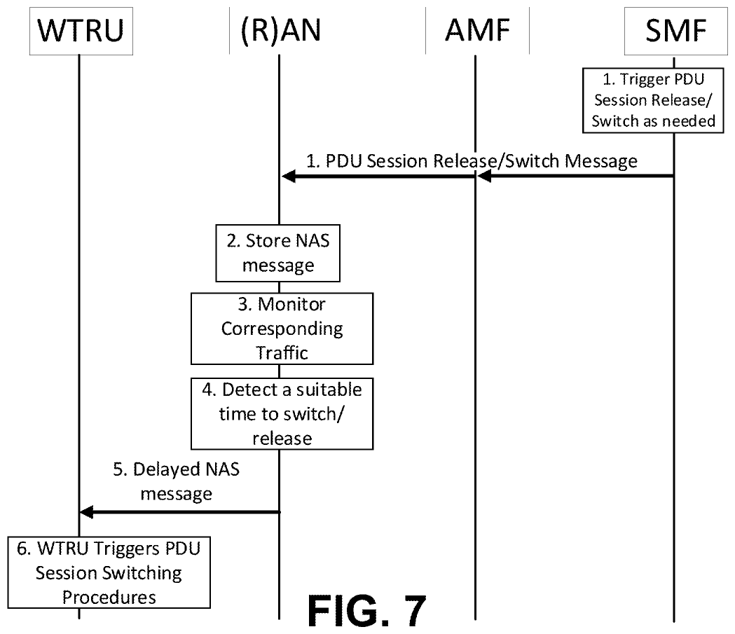

A RAN node such as a base station may be configured to detect a suitable time for a PDU session release and/or trigger the PDU session release. The RAN node may achieve this, for example, by delaying a NAS message that may carry a PDU session release command to a WTRU, as illustrated in FIG. 7.

At 1 of FIG. 7, an SMF may determine that a PDU session release may be performed. The determination may be made, for example, in similar manners as described at 1 of FIG. 5. Also at 1 of FIG. 7, the SMF may send a message to an AMF. The message to the AMF may include an N1 container that may carry a PDU session release command. The message to the AMF may include an N2 SM resource release request message. The N2 SM resource release request message may include an indication that the RAN node may delay a NAS message, for example, until the RAN node detects a suitable time to release the PDU session (e.g., an EoB detected on an identified QoS flow). The N2 message may specify a time to live value for the NAS message. The time to live value may indicate to the RAN node that the N1 container may be delivered to a WTRU before the time to live time expires (e.g., regardless of whether the RAN node has detected a suitable time to release the PDU session). This message may specify the applications, PDU sessions, or flows the configuration may be apply to. The SMF may specify how a suitable time for releasing a PDU session may be defined (e.g., based on the parameters and methods described herein).

At 2 of FIG. 7, the RAN node may store the received NAS message, for example, as per the N2 message received from the SMF at 1.

At 3 of FIG. 7, the RAN node may monitor traffic on a specified session or flow for a suitable time to release a PDU session. If the SMF does not specify the detection parameters, the RAN node may use a default configuration on the RAN node to determine what traffic to monitor and/or how to detect a suitable time to release the PDU session.

At 4 of FIG. 7, the RAN node may detect traffic that may match the criteria for a suitable time to release the PDU session. The RAN node may also predict that such traffic may arrive within a time period, for example, with a certain level of probability or confidence. In some cases, the RAN node may incorporate detection information received from an application layer, a WTRU, and/or a UPF (e.g., an EoB indication).

At 5 of FIG. 7, the RAN node may send the delayed NAS message to a WTRU. The RAN node may indicate that the NAS message may be a delayed message received from the SMF and conveyed to the WTRU. The indication may be provided, for example, by including the delay information in the RRC message that may carry the NAS message. If the RAN node could not detect a suitable time within a time-to-live (TTL) value specified, the RAN node may discard the stored NAS message. The RAN node may send a message to the SMF to inform the SMF that the NAS message was not delivered. If the RAN node could not detect a suitable time within the TTL specified, the RAN may deliver the NAS message and send a message to the SMF to inform the SMF that the NAS message was delivered due to the expiration of a timer.

At 6 of FIG. 7, a WTRU may trigger a PDU session release/re-establishment, based on the received NAS message.

When the SMF sends a PDU session release command to the RAN node via the AMF, the SMF may also send an N2 resource release request (e.g., with a PDU session ID) for the RAN node to release RAN resources associated with the PDU session. Since forwarding the PDU session release request message to the WTRU may be delayed (e.g., after detection of a suitable time to release the PDU session), the N2 resource release may also be delayed so that the RAN node may keep the allocated resources until the RAN node detects a suitable time to release the delayed message, until the NAS message has been sent, until the PDU session release/switch is executed, or a TTL is exceeded.

As illustrated by FIG. 7, a RAN node may (e.g., at 1 of FIG. 1) receive an N2 message that may include a NAS message to be sent to a WTRU and/or an indication that the message may not be sent to the WTRU until a condition is met. The message may indicate the condition such as detection of an EoB indication in a QoS flow. The message may indicate a time value and/or that the condition may be that the indicated time value may have passed since the RAN node receives the message. The RAN node may (e.g., at 2-4 of FIG. 7) detect the condition and, based on detecting the condition, send (e.g., at 5 of FIG. 7) the NAS message to the WTRU. The NAS message may be sent to the WTRU in an RRC message and the RRC message may indicate to the WTRU that the message is a delayed message from the SMF.

Based on not detecting the condition within a time period, the RAN node may (e.g., at 5 of FIG. 7) send a message to the SMF to inform the SMF that the NAS message was not delivered.

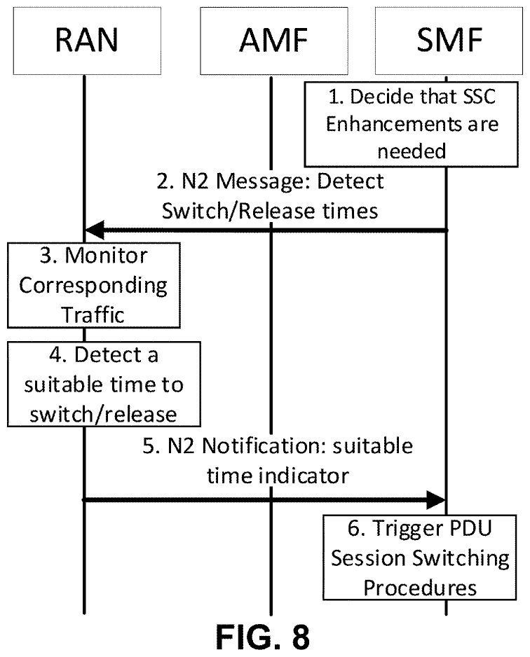

A RAN node such as a base station may detect a suitable time for releasing a PDU session, and an SMF may initiate the release based on detection information received from the RAN node. FIG. 8 illustrates such an example.

At 1 of FIG. 8, an SMF may determine that a PDU session release may be performed. The determination may be made, for example, in similar manners as described at 1 of FIG. 5.

At 2 of FIG. 8, the SMF may send a message to a RAN node such as a base station over the N2 interface (via the AMF), requesting the RAN node to detect a suitable time to release a PDU session. The message may indicate the applications, PDU sessions, or QoS flows that may be monitored to identify the suitable time for the release of the PDU session. The SMF may specify how a suitable time may be defined (e.g., based on the parameters and methods described herein).

At 3 of FIG. 8, the RAN may monitor traffic on a specified session or flow. If the SMF may not have specified how to detect the suitable time for releasing the PDU session, the RAN node may use a default method.

At 4 of FIG. 8, the RAN node may detect traffic that may match the criteria for a suitable time to release the PDU session, or the RAN node may predict that such traffic may arrive within a time period, for example, with a certain level of probability or confidence.

At 5 of FIG. 8, the RAN may send a notification message to the SMF indicating that a suitable time to release has occurred or may occur in a certain period of time. The message may indicate the criteria or rules used for the detection or prediction. The message may specify if the RAN node has detected the result or predicted the result. The message may include both detected and predicted results.

At 6 of FIG. 8, the SMF may determine, based on information received from the RAN node (e.g., as well as information received from a WTRU and/or a UPF), that a PDU session release may be performed, and the SMF may trigger a PDU session release procedure. The SMF may take into account both predicted and detected results, if available, in the determination.

As illustrated by FIG. 8, an SMF may (e.g., at 1 of FIG. 8) determine that the traffic of a PDU session, which may be associated with SSC mode 2 and/or an anchor UPF, may be better served if it is associated with a second PDU session and/or a second anchor UPF. The SMF may (e.g., at 2 of FIG. 8) send a request to a RAN node requesting a notification of detection of a suitable time to release the PDU session. The message may identify the PDU session. The message may indicate one or more QOS flows of the PDU session that may be monitored for detecting the suitable time for releasing the PDU session. The SMF may (e.g., at 5 of FIG. 8) receive a notification from the RAN node that may indicate detection of a suitable time to release the PDU session. Based on the notification, the SMF may (e.g., at 6 of FIG. 8) determine to release the PDU session.

Other techniques may be used to determine a suitable time for releasing a PDU session. For example, an SMF may determine the suitable time to perform the PDU session release based on known information about traffic carried over the PDU session. For example, the SMF may know the periodicity of the traffic based on information obtained from an AF, or the periodicity may be determined at a UPF and provided to the SMF through N4 signaling. The periodicity may also be determined by a WTRU and provided to the SMF through control plane signaling. As another example, the SMF may know the jitter of the traffic carried over a PDU session based on information provided by the UPF and/or the WTRU. Based on this information, the SMF may determine time periods of low activity and perform a PDU session release and/or re-establishment during these periods.

The network (e.g., an SMF) may inform the AF that a PDU session release and/or re-establishment may be performed. In response, the AF may send an indication to the SMF about a suitable time to perform the procedure. The AF may be able to buffer traffic during such a time to minimize data loss during a service interruption.

One or more of the techniques for determining a suitable time to perform a PDU session release and/or re-establishment may be combined. For example, an SMF may ask a UPF to determine a suitable time for the release and/or re-establishment so as to minimize the impact of a service interruption for downlink traffic, and the SMF may (e.g., concurrently) ask a WTRU to determine a suitable time so as to minimize the impact of a service interruption for uplink traffic. The conditions for determining the suitable time may be different for the UPF and the WTRU. For example, the UPF may be asked to determine the suitable time based on an EoB while the WTRU may be asked to determine the suitable time based on being in a power saving state. A node (e.g., a UPF or WTRU) configured to determine a suitable time for releasing and/or re-establishing a PDU session may receive an indication from the SMF that a PDU session release and/or re-establishment may be performed, and/or that the node may detect a suitable time for doing so. The node may also be configured to monitor for such a suitable time and indicate detection of the suitable time to the SMF. This may be useful in cases where a PDU session release or re-establishment may not be delayed.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor.

Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A network node, the network node comprising:
a processor, wherein the processor is further configured to:
send a first message to a device, wherein the first message indicates that the device is to monitor for an event associated with releasing a protocol data unit (PDU) session;
receive a second message from the device, wherein the second message indicates a notification that the event has occurred; and
send a third message in response to receiving the notification, wherein the second message indicates that a release of the PDU session is to be triggered.

2. The network node of claim 1, wherein the processor is further configured to:
determine configuration information associated with the PDU session, wherein the configuration information comprises at least one of a data network name (DNN) or a single slice selection assistance information (S-NSSAI);
determine, based on the configuration information, that device coordination is to be used for releasing the PDU session; and
determine the event when it is determined that device coordination is to be used for releasing the PDU session.

3. The network node of claim 1, wherein the event is associated with an end of burst.

4. The network node of claim 1, wherein the PDU session is associated with session and service continuity (SCC) mode 2.

5. The network node of claim 1, wherein the processor being configured to send the first message to the device comprises the processor being configured to send the first message to the device when it is determined that the PDU session is to be released.

6. The network node of claim 1, wherein the second message further indicates at least one of a time to release the PDU session, a criterion for predicting the time to release the PDU session, or a rule for predicting the time to release the PDU session.

7. The network node of claim 1, wherein the second message further indicates a confidence level, wherein the confidence level indicates a probability that the event occurred.

8. A network node, the network node comprising:
a processor, wherein the processor is further configured to:
receive a first message from a device, wherein the first message indicates that the network node is to monitor for an event associated with releasing a protocol data unit (PDU) session;
determine the event has occurred when a criterion is satisfied;
send a second message to the device, wherein the second message indicates a notification that the event has occurred; and
receive a third message in response to sending the notification, wherein the second message indicates that a release of the PDU session is to be triggered.

9. The network node of claim 8, wherein the event is associated with an end of burst.

10. The network node of claim 8, wherein the PDU session is associated with session and service continuity (SCC) mode 2.

11. The network node of claim 8, wherein the processor is further configured to determine at least one of a time to release the PDU session, a criterion for predicting the time to release the PDU session, or a rule for predicting the time to release the PDU session.

12. The network node of claim 8, wherein the second message further indicates at least one of a time to release the PDU session, a criterion for predicting the time to release the PDU session, or a rule for predicting the time to release the PDU session.

13. The network node of claim 8, wherein the criterion is at least one of an end of burst, a time to release the PDU session, a traffic threshold, a packet threshold, a duration of time that has expired, an arrival of data traffic, or an arrival of an amount of data during a duration of time.

14. A method performed by a network node, the method comprising:
sending a first message to a device, wherein the first message indicates that the device is to monitor for an event associated with releasing a protocol data unit (PDU) session;
receiving a second message from the device, wherein the second message indicates a notification that the event has occurred; and
sending a third message in response to receiving the notification, wherein the second message indicates that a release of the PDU session is to be triggered.

15. The method node of claim 14, wherein the method further comprises:
determining configuration information associated with the PDU session, wherein the configuration information comprises at least one of a data network name (DNN) or a single slice selection assistance information (S-NSSAI);
determining, based on the configuration information, that device coordination is to be used for releasing the PDU session; and
determining the event when it is determined that device coordination is to be used for releasing the PDU session.

16. The method of claim 14, wherein the event is associated with an end of burst.

17. The method of claim 14, wherein the PDU session is associated with session and service continuity (SCC) mode 2.

18. The method of claim 14, wherein sending the first message to the device comprises sending the first message to the device when it is determined that the PDU session is to be released.

19. The method of claim 14, wherein the second message further indicates at least one of a time to release the PDU session, a criterion for predicting the time to release the PDU session, or a rule for predicting the time to release the PDU session.

20. The method of claim 14, wherein the second message further indicates a confidence level, wherein the confidence level indicates a probability that the event occurred.
